(19) United States
(12) Patent Application Publication
(10) Pub. No.: US 2006/0149517 A1
(43) Pub. Date: Jul. 6, 2006

(54) Methods and systems for spring design and analysis

(75) Inventors: Sami Ibrahim El-Sayed, Bloomington, IL (US); Avtar Singh Sandhu, Bloomington, IL (US); Dana Ray Coldren, Fairbury, IL (US); Rabah Seffal, Bloomington, IL (US)

Correspondence Address: CATERPILLAR/FINNEGAN, HENDERSON, L.L.P., 901 New York Avenue, WASHINGTON, DC, 20001-4413, US

(73) Assignee: Caterpillar Inc.

(21) Appl. No.: 11/024,723

(22) Filed: Dec. 30, 2004

(51) Int. Cl. G06G 7/48

(52) U.S. Cl. 703/7

(57) ABSTRACT

A spring design method is disclosed. The method begins with inputting a first set of design parameters for a spring. The design parameters include a parameter that provides an estimate of non-linearity in the spring. The spring design method determines a spring design based on the first set of design parameters. A spring design and analysis method is disclosed. The method begins with creating a spring design. The spring design includes a parameter that provides an estimate of non-linearity in the spring design. The spring design and analysis method creates a spring animation file that enables stress levels in a spring design to be identified at the coil level. The spring design method next identifies the coil in the spring design having the lowest dynamic fatigue factor and determines whether the lowest dynamic fatigue factor is acceptable.

### TECHNICAL FIELD

This disclosure relates generally to spring design and analysis. More particularly, the disclosure relates to systems and methods for designing and analyzing non-linear and linear springs under dynamic loading conditions.

### BACKGROUND

Helical compression springs and other springs are important components in numerous mechanical devices. Often under extreme operating conditions, the springs encounter severe stress and strains. For example, helical compressions springs are used in fuel systems to control loads and injection timing. These fuel systems deliver accurate volumes of fuel for precise timing and provide multiple injections for low emissions with complete combustion and maximum fuel economy. Fuel system springs experience high dynamics due to rapid acceleration and deceleration during and after injection events. Fuel systems springs have been pushing the current spring design methodologies to the technical limit in order to improve fatigue life and high speed performance.

U.S. Pat. No. 6,145,762 to Orloff et al. discloses a variable rate spring for use in a diesel fuel injection system. Orloff's variable rate spring includes coils with varying pitch so that the pitch of the coils near the spring ends is reduced. According to Orloff, the use of a variable rate, i.e., non-linear spring, addresses the problem of premature fatigue failures caused by the return spring oscillating at or above its natural frequency. In operation, if the spring resonates, then the coils at the spring ends close and open and change the frequency of spring thereby damping the resonance.

Orloff provides an example of an advantage associated with the use of non-linear springs in certain environments. Orloff, however, does not disclose how such a spring may be designed absent the traditional trial and error technique. Indeed, existing spring design and analysis tools generally consider linear springs under the influence of non-dynamic mechanical forces. Existing tools do not account for dynamic aspects of spring design.

Moreover, once a spring design is created, engineers have historically relied upon static stress to test and perfect those designs. However, this approach is not reliable for springs that will encounter dynamic forces in operation. Static analysis calculates one stress value for all coils, whereas dynamic analysis calculates stress levels in each individual coil. Moreover, dynamic analysis may consider coil clashes, friction, and other factors making the analysis results more realistic. Considering only static stress may result in springs that encounter spring load loss and fatigue failures during operation.

The present disclosure provides systems and methods for spring design and analysis that avoid some or all of the aforementioned shortcomings in the prior art.

### SUMMARY OF THE INVENTION

According to one embodiment, a spring design method is disclosed. The spring design method begins with the input of a first set of spring design parameters. The design parameters include a parameter that provides an estimate of non-linearity in the spring. A spring design is determined based on the first set of spring design parameters. If the parameter that provides an estimate of non-linearity in the spring is non-zero, then the determining step determines a non-linear spring design.

According to another embodiment, a spring design and analysis method is disclosed. The method begins with creation of a spring design. The spring design includes a parameter that provides an estimate of non-linearity in the spring design. The spring design is then meshed with its break elements. A finite element analysis is performed on the meshed spring and an animation file is created based on the finite element analysis. The spring animation file enables stress levels in the spring design to be identified at the coil level. The spring design and analysis method then identifies the coil in the spring that has the lowest dynamic fatigue factor. The method also includes a determination of whether the lowest dynamic fatigue factor is acceptable.

According to still another embodiment, a spring design system is disclosed. The spring design system includes a user interface, a processor and a display device. The user interface enables inputting a first set of design parameters for a spring. The design parameters include a parameter that provides an estimate of non-linearity in the spring. The processor is configured to determine a spring design based on the first set of design parameters. The processor is configured to determine a non-linear spring design when the parameter that provides an estimate of non-linearity in the spring is non-zero. The display device displays the spring design.

According to yet another embodiment, a spring design and analysis system is disclosed. The system includes a processor and a display device. The processor is configured to create a spring design including a parameter that provides an estimate of non-linearity in the spring design. The processor is also configured to: mesh the spring design with its break elements; perform a finite element analysis on the meshed spring; create a spring animation file based on the finite element analysis, identify the coil in the spring design having the lowest fatigue factor; and determine whether the lowest fatigue factor is acceptable. The spring animation file enables stress levels in the spring design to be identified at the coil level. The display device displays the animation to a user.

According to another disclosed embodiment, a non-linear spring design method is disclosed. The method begins with inputting design criteria for a spring. The design criteria include a parameter that provides an estimate of non-linearity in the spring. The method outputs a non-linear spring design based on the design criteria.

### BRIEF DESCRIPTION OF THE DRAWINGS

FIG. 1 illustrates an exemplary system environment in which methods and systems consistent with features and principles of the present disclosure may be implemented;

FIG. 2 illustrates an exemplary client system consistent with embodiments of the present disclosure;

FIG. 3 illustrates an exemplary server system consistent with embodiments of the present disclosure;

FIG. 4 illustrates a flow chart of an exemplary spring design process consistent with embodiments of the present disclosure;

FIG. 5 illustrates an exemplary input/output window consistent with embodiments of the present disclosure;

FIG. 6 illustrates an exemplary default selection window consistent with embodiments of the present disclosure;

FIG. 7 illustrates an exemplary engineering drawing window consistent with embodiments of the present disclosure;

FIG. 8 is an exemplary graph illustrating a non-linear spring design curve consistent with embodiments of the present disclosure.

FIG. 9 illustrates a flow chart of an exemplary spring analysis process consistent with embodiments of the present disclosure; and

FIGS. 10a-10c illustrate animation frame captures consistent with embodiments of the present disclosure.

### DETAILED DESCRIPTION

Reference will now be made in detail to the drawings. Wherever possible, the same reference numbers will be used throughout the drawings to refer to the same or like parts.

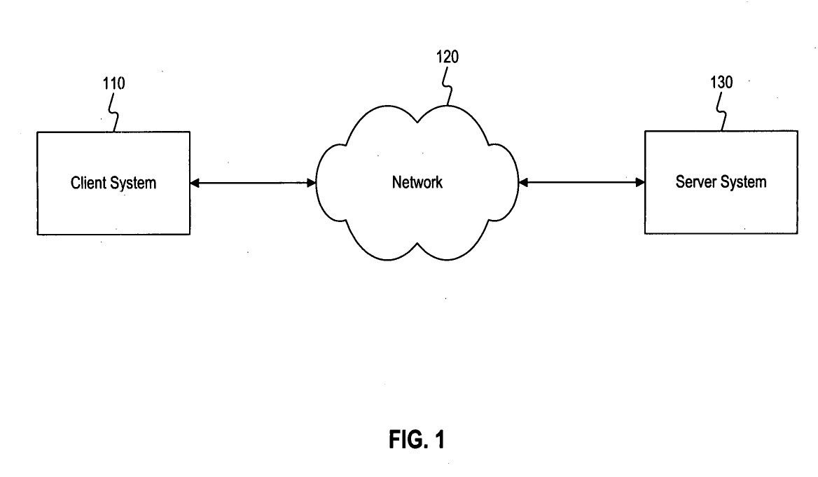

FIG. 1 illustrates an exemplary system environment in which features and principals consistent with the present disclosure may be implemented. As shown, the exemplary system environment may include a client system 110, a network 120 and a server system 130. Although FIG. 1 shows only one client and only one server, one skilled in the art would realize that any number of these elements may be implemented within the computing environment shown in FIG. 1 without departing from the scope of the present disclosure.

Client system 110 may be a desk top computer, work station, lap top, personal digital assistant, or any other similar computer system known in the art. For example, client system 110 may include a processor, associated memory, and numerous other elements and functionalities available in computer systems. These elements may include input/output devices, such as a keyboard, mouse and display, although these input means may take other forms. Also, included in client system 110, may be a network interface and a web browser application stored within a local memory for communicating with network 120. In one aspect of the present disclosure, a user may operate client system 110 to perform functions consistent with certain features related to the present disclosure. A user may be any individual that operates client system 110 to perform functions consistent with the present disclosure. For example, a user may include an engineer operating client system 110 to design and analyze springs consistent with features and aspects of the present disclosure.

Network 120 interconnects client system 110 and server system 130. Network 120 may include one or more communication networks, including the internet or any other similar network that supports web-based processing. Further, network 120 may include the wireline and/or wireless-based networks. According to one embodiment, network 120 may be a local area network (LAN), a wide area network (WAN), a dedicated intranet, the internet, and/or a wireless network.

Server system 130 may be a computer system that provides information to a requesting entity, e.g., client system 110, through network 120. Server system 130 may include a desk top computer, workstation, mainframe, or any other similar server side system known in the art. Further, server system 130 may include and/or is connected to one or more memory devices, such as databases. In one configuration, server system 130 provides various components or modules used in the spring design and analysis processes.

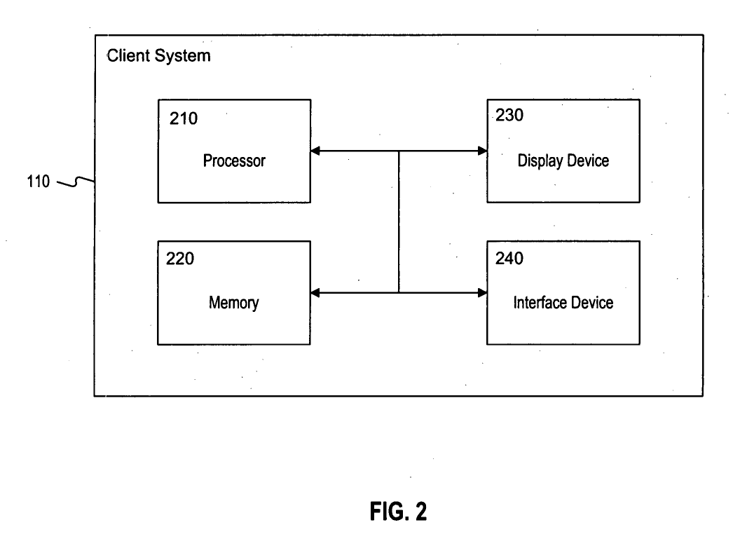

FIG. 2 illustrates an exemplary client system 110 in which features and principals consistent with the present disclosure may be implemented. Client system 110 is a computing system that is operated by a user. Client system 110 may include, for example, a processor 210, memory 220, display device 230, and an interface device 240. Processor 210 may be one or more processor devices, such as a microprocessor, lap top computer, desk top computer, workstation, mainframe, etc. that execute program instructions to perform various functions. Memory 220 may be one or more storage devices that maintain data (e.g., instructions, software applications, etc.) used by processor 210. In one embodiment of the present disclosure, memory 220 includes browser and other software that enables client system 110 to retrieve content from external sources. Display device 230 may be any known type of display device that presents information to the user operating client system 110. Interface device 240 may be one or more known interface modules that facilitate the exchange of data between the internal components of client system 110 and external components such as server system 130. Further, interface device 240 may include a network interface device that allows client system 110 to receive and send data to and from network 120. In one embodiment of the present disclosure, memory 220 includes various software components and modules used in the spring design and analysis processes outlined in the present disclosure.

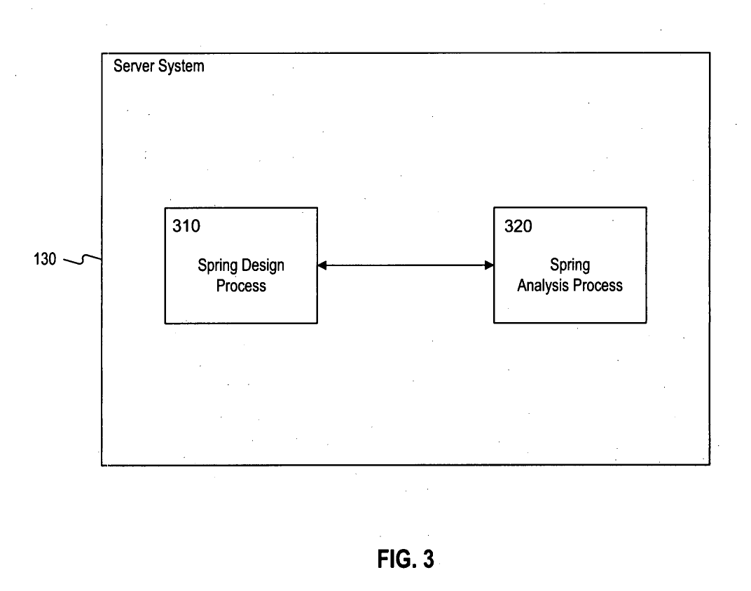

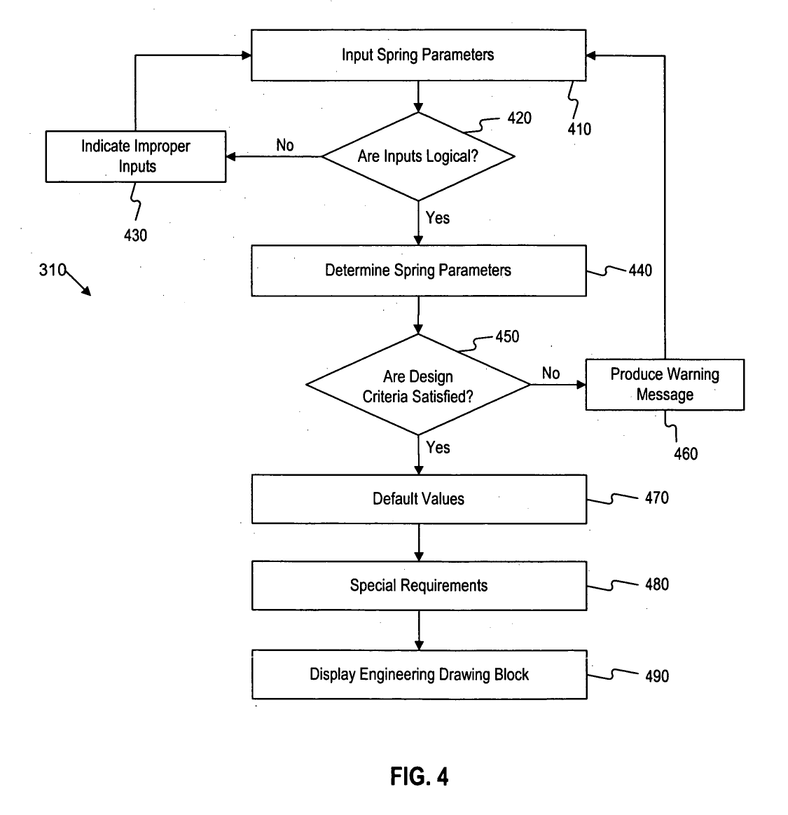

FIG. 3 illustrates an exemplary block diagram of server system 130 consistent with certain principals related to the present disclosure. As shown, server system 130 may include a spring design process 310, and a spring analysis process 320. The processes included in server system 130 may be stored in one or more memory devices and executed by one or more processors running within server system 130. Alternatively, some or all of the processes may be subsystems of server system 130 that include software, hardware, processing systems, memory, support systems, and any other elements that enable each subsystem to perform their respective functions consistent with features of the present disclosure. One skilled in the art would realize that the configuration of server system 130, as shown in FIG. 3, is exemplary and not intended to be limiting. A number of different processes and configurations may be added to and/or removed from server system 130 without departing from the scope of the present disclosure. For example, either or both of processes 310 and 320 may be located remotely from and accessible by server system 130. Each of the processes 310 and 320 included within server system 130 may include one or more processes to perform various functions consistent with aspects and features of the present disclosure. Processes 310 and 320 will now be explained in detail in conjunction with FIGS. 4 through 10.

### INDUSTRIAL APPLICABILITY

Spring design process 310 is capable of considering non-linearity and designing a spring accordingly. According to one embodiment, spring design process 310 designs springs using a progressivity factor. The progressivity factor estimates the non-linearity in a given spring application. Spring design process 310 accordingly designs non-linear springs based on the progressivity factor.

Additionally, spring design process 310 may determine a spring design that includes an estimate of the dynamic fatigue factor and determines guiding conditions for the spring design. The fatigue factor, or fatigue limit, is the maximum stress that an article can repeatedly endure without failing. The dynamic fatigue factor is the maximum dynamic stress that an article can repeatedly endure without failing. Spring design process 310 estimates the dynamic fatigue factor. Generally, the guiding conditions for a spring indicate the dimensions of the part with which the spring being designed will interact. For example, for a coil spring operating within a cylinder, the guiding indicates dimensional limits for the cylinder. As another example, if the coil spring is to be mounted on a pin, the guiding indicates the dimensional limits of that pin.

Spring design process 310 may include a process or processes running within client system 110 and operated by a user to design springs. An exemplary embodiment of spring design process 310 is depicted in FIG. 4. Spring design process 310, shown in FIG. 4, includes steps 410 through 490 that enable both linear and non-linear spring design.

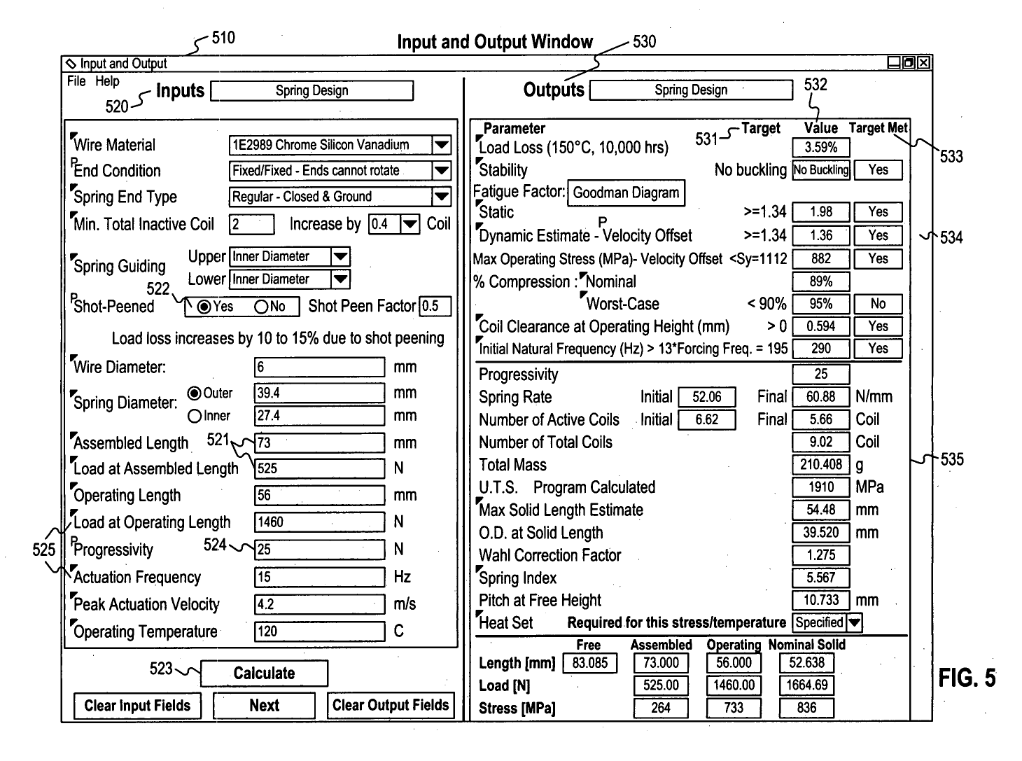

Spring design process 310 begins with an input step 410 wherein parameters are input. At step 420 it is determined whether the inputs are logical. If not, a user is provided with an indication of illogical inputs at step 430 and control is returned to input step 410. When a logical set of inputs is developed, spring parameters are determined at step 440. Various embodiments include the ability to determine spring design parameters for both linear and non-linear springs. At step 450, it is determined whether any available design criteria have been satisfied by the calculated spring parameters. If there are design parameters that are not satisfied, control returns to input step 410 after producing a warning message at step 460. At step 470 certain default values for the designed spring are determined. At step 480, any special requirements for the designed spring are determined. At step 490, an engineering drawing block representative of the designed spring is displayed. Each of these steps will be explained in more detail in conjunction with FIGS. 5-8.

FIG. 5 depicts an exemplary input/output window for spring design process 310. According to one embodiment, input/output window 510 includes a graphical user interface that enables entry of design parameters for a spring to be designed. Input/output window 510 includes input side 520 and output side 530. As can be seen from FIG. 5, input side 520 includes a number of input boxes 521, radio buttons 522, and operational controls 523. Input boxes 521 include input boxes for a number of typical spring design parameters. As shown in FIG. 5, input boxes 521 include: wire material, end condition, spring end type, minimum total inactive coil, upper and lower spring guiding, wire diameter, spring diameter, assembled length, load at assembled length, operating length, load at operating length, progressivity, actuation frequency, peak actuation velocity, and operating temperature. Radio buttons 522 enable a user to select certain on/off type of spring parameters. For example, radio buttons 522 include yes/no radio buttons to select whether a spring should be shot-peened. Radio buttons 522 also include a radio button to select whether or not a spring diameter is the outer diameter or the inner diameter. Operational controls 523 include buttons for calculate, clear input fields, next, and clear output fields. As will be apparent to one of ordinary skill in the art, any combination of input boxes, radio buttons and operational controls may be provided.

A number of the input boxes 521 on input side 520 of input/output window 510 will now be explained. In particular, spring guiding, load, and length input boxes will be explained. Spring guiding input boxes enable a user to enter the guiding conditions for the spring at its upper and lower ends. Spring guiding input boxes include drop down menus that enable a user to select certain guiding conditions, such as inner diameter and outer diameter. The drop down box may also enable a user to select no guiding conditions to indicate the spring design will not take guiding into account. As will be apparent to one of skill in the art, inner diameter refers to a spring that is mounted at one end using a cylindrical element, such as a pin, inserted within the spring coils. Outer diameter refers to a spring that is mounted at one end by fixing the spring within a cylinder. Other guiding conditions are possible and would be known to those skilled in the art.

According to one embodiment, input/output window 510 includes input boxes for assembled length, load at assembled length, operating length, and load at operating length. The assembled length of a spring is the length of the spring as it is incorporated into the device within which it will operate. In contrast, the operating length of a spring is the length of a spring as it is incorporated into the device in which it is operating at its minimum length. That is, a spring's operating length is its length when experiencing the maximum operating load. The assembled load is the load that the spring will experience when incorporated into its operating device, when that operating device is not operating. That is, the load at assembled length refers to the static load the spring will typically be under. In contrast, the load at operating length refers to the load the spring will endure when it is at its operating length. That is, the load at operating length refers to the maximum load the spring will endure under normal operation.

FIG. 5 also includes user help icons 525. According to one embodiment, user help icons 525 include pop-up windows that are actuated when a cursor is positioned over the icon. As an example, when a cursor is positioned over the user help icon 525 below an operating length, a pop-up window may appear that explains that the load at operating length should be greater than the load at assembled length. Similar messages may be displayed in a pop-up window for each of the other input boxes 521 within input side 520 of input/output window 510. As will be apparent to one of ordinary skill in the art, other user help functionalities may be employed to deliver messages to a user. For example, user help icons 525 may include icons that generate a user help menu with an alphabetized index of user help items.

Input side 520 of input/output window 510 also includes progressivity input box 524. According to one embodiment, spring design process 310 uses the progressivity factor to estimate the non-linearity in a given spring application. Spring design process 310 accordingly designs non-linear springs based on the progressivity factor. A non-linear spring includes, for example, a spring that is designed having certain parameters that enable the spring to respond to non-linearity in operation. Progressivity input box 524 enables an operator to input a progressivity factor to indicate non-linearity desired in the spring design. According to one embodiment, progressivity input box 524 enables selection of a spring design algorithm. More specifically, if the progressivity factor entered in progressivity input box 524 is non-zero, then spring design process 310 utilizes a non-linear spring design algorithm. If a progressivity factor of zero is entered into progressivity input box 524, then spring design process 310 utilizes a linear spring design algorithm. According to another embodiment, spring design process 310 includes a single spring design algorithm that includes the progressivity input.

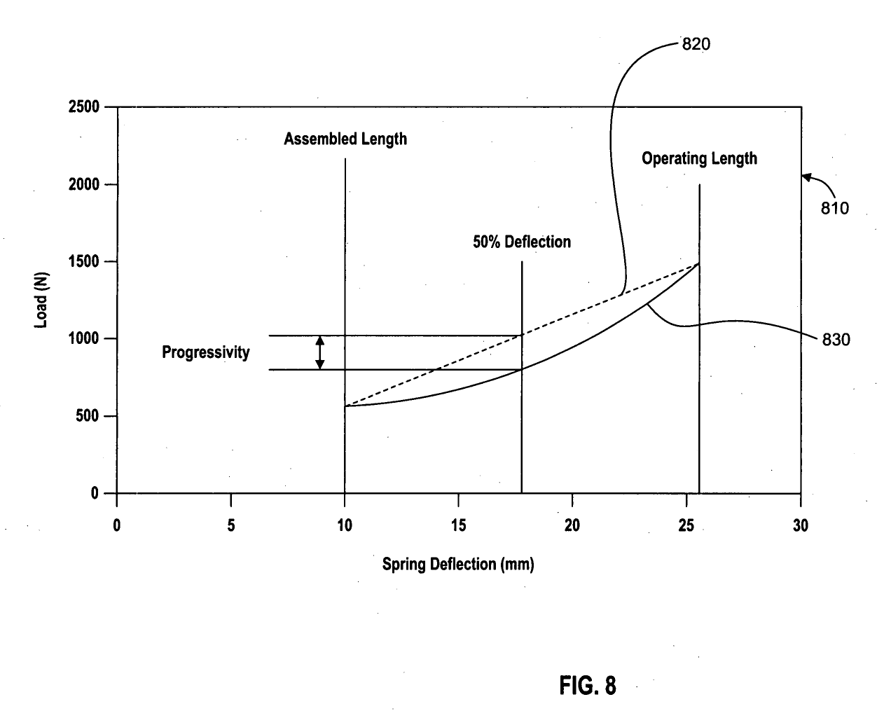

FIG. 8 provides a graphical illustration 810 of the progressivity factor. In FIG. 8, the load on the spring is indicated on the vertical access in Newtons and the spring deflection is indicated on the horizontal axis in millimeters. Referring to FIG. 8, graphs 820 and 830 show spring response curves for two different spring designs. Spring response curve 820 includes the response curve for a hypothetical perfectly linear spring design. Spring response curve 830 includes the response curve for a non-linear spring design. The progressivity factor of the non-linear spring includes the load differential between the non-linear spring and the hypothetical perfectly linear spring at 50% deflection. As can be seen from FIG. 8, the progressivity factor is measured in Newtons. As will be apparent to one having skill in the art, the desired progressivity factor may be determined using known spring design techniques.

Returning to FIG. 4 in step 420, the various inputs on input side 510 are checked for logic. According to one embodiment, logic check step 420 includes a check to determine that all necessary input boxes are filled. According to another embodiment, logic check step 420 determines whether or not the various inputs within input boxes 521 are logical. For example, the values entered into operating load input box and assembled load input box should be consistent with known spring design parameters. If the operating load entered is smaller than the assembled load entered, this would indicate noncompliance with known spring design methodologies. According to one embodiment, such a set of inputs would generate a warning message to the user that the values entered are illogical. As will be apparent to one having skilled in the art, various input checks may be made at step 420.

At step 430, if illogical inputs are present, spring design process 310 provides an indication of which inputs are illogical. According to one embodiment, spring design process 310 indicates an inappropriate or illogical input by highlighting in bold the input field. According to another embodiment, spring design process 310 indicates an illogical or inappropriate input by indicating with color the input box or field that contains the illogical or inappropriate input. It will be apparent to one having skill in the art that various mechanisms to indicate an illogical or inappropriate input may be employed.

If in step 420 it is determined that all inputs are logical, then at step 440 the spring is designed. According to one embodiment, determining a spring design includes calculating certain spring parameters. According to one embodiment, spring parameters are calculated when the calculate operational button on input side 520 of input/output window 510 is actuated. According to one embodiment, spring design process 310 includes non-linear and linear spring design algorithms. When the calculate functional button 523 is actuated, a check is made of progressivity factor 524 to determine whether it is non-zero. If progressivity factor 524 is non-zero, then a non-linear spring design algorithm is used to calculate spring parameters at step 440. If progressivity factor 524 is zero, then a linear spring design algorithm is used to calculate spring design parameters at step 440.

According to one embodiment, spring design step 440 is accomplished using an algorithm that determines the spring rate at assembled length, the spring rate at operating length, the number of active coils at assembled length and the number of active coils at the operating length. According to one embodiment, an algorithm for determining the non-linear spring design is developed by driving an equation to fit the non-linear spring characteristic curve 830 shown in FIG. 8. As will be apparent to one having skill in the art, the spring rate an any given point along curve 830 is the slope of the tangent to the curve at that point. According to one embodiment, the algorithm can be determined by combining two linear equations representative of the tangent lines at the assembled length and operating length. The first linear equation may represent the actual tangent line at the assembled length. The second linear equation may represent an approximation of the tangent line at the operating length. Alternatively, the actual tangent line at the operating length may be used along with an approximation of the tangent line at the assembled length. The two linear equations are combined to arrive at the non-linear spring design algorithm. It will be apparent to one having ordinary skill in the art that various spring design algorithms capable of linear and non-linear spring design may be used.

According to one embodiment, spring design process 310 estimates the dynamic fatigue factor at step 440. The dynamic fatigue factor is the maximum dynamic stress that an article can repeatedly endure without failing. According to one embodiment, spring design process 310 estimates the dynamic fatigue factor using an enhanced fatigue factor estimate process. As will be apparent to one having ordinary skill in the art, dynamic fatigue factor can be estimated mathematically using a well know technique, for example a well known equation. That well known technique, however, does not always provide an accurate estimate of dynamic fatigue factor. According to one embodiment, spring design process 310 estimates the dynamic fatigue factor for the spring design using the well known estimating technique and a calibration factor derived from actual stress tests done on a number of spring samples. According to one embodiment, the calibration factor is derived by comparing actual dynamic fatigue factors developed through stress tests on actual springs to dynamic fatigue factor estimates derived using well known techniques.

Spring design process 310 may determine a springs guiding conditions at step 440. Generally, the guiding conditions for a spring indicate the dimensions of the part with which the spring being designed will interact. For example, for a coil spring operating within a cylinder, the guiding indicates dimensional limits for the cylinder. As another example, if the coil spring is to be mounted on a pin, the guiding indicates the dimensional limits of that pin. According to one embodiment, spring design process 310 determines spring guiding limits using a spring guiding relationship. The spring guiding relationship may be developed by evaluating guiding conditions for known springs. For example, a spring guiding relationship may be developed by plotting guiding condition data for known springs and fitting a curve to that plotted data. Alternatively, spring guiding relationship may be developed by building a look-up table from guiding condition data for known springs. It will be apparent to one having ordinary skill in the art that a spring's guiding conditions, and therefore spring guiding relationship, vary based on the spring's intended use.

The determined spring design parameters are displayed within output side 530 of input/output window 510. Output side 530 shown in FIG. 5 includes a top portion 534 and a bottom portion 535. Top portion 534 of output side 530 includes a number of determined spring design parameters. As shown in FIG. 5, spring design parameters in top portion 534 include load loss, stability, fatigue factor, static fatigue factor, dynamic fatigue factor estimate, maximum operating stress, percent compression, coil clearance, and initial frequency. Top portion 534 also includes column 531 for target values, column 532 for calculated values, and column 533 to indicate whether a target was met. According to one embodiment, column 531 includes a target calculated by spring design process 310 for each of the various spring design parameters. According to another embodiment, column 531 includes target values entered by a user for each of the various spring design parameters in top portion 534. Column 532 includes the calculated values for each of the spring design parameters listed in top portion 534. According to one embodiment, the values for the spring design parameters in column 532 are calculated using either a linear or non-linear spring design algorithm as described above. Column 533 of top portion 534 provides an indication of whether or not the spring design parameter meets its target. According to one embodiment, target met column 533 includes a yes or no indication of whether or not the calculated spring design parameter meets its target. According to another embodiment, target met column 533 of top portion 534 includes a user entered indication of whether or not a target is met.

Bottom portion 535 of output side 530 include a number of spring design parameters that are either entered by a user of spring design process 310 or calculated by spring design process 310. According to the embodiment shown in FIG. 5, bottom portion 535 includes calculated values for spring rate, number of active coils, number of total coils, total mask, U.T.S., max solid length, outside diameter, Wahl correction factor, spring index, pitch and heat set. Bottom portion 535 also lists the user-entered progressivity factor. As will be apparent to one having skill in the art, various spring design parameters can be included within or excluded from the spring design parameters listed in the top portion 534 and bottom portion 535 of output side 530 without departing from scope of the present disclosure.

Returning to FIG. 4, at step 450, it is determined whether design criteria are satisfied. It the design criteria are not satisfied, control returns to input step 410 where the spring design parameters can be adjusted. According to one embodiment, target met column 533 of top portion 534 provides an indication of whether or not design criteria are satisfied for the particular spring design project. At step 460, spring design process 310 produces warning messages indicating that spring design criteria are not met. According to the embodiments shown in FIG. 5, warning messages include a yes/no indication in target met column 533 of top portion 534. A no indicates that design criteria were not satisfied and constitutes the warning message of step 460 in FIG. 4. According to another embodiment, a pop-up window could be used to indicate that design criteria were not met. It will apparent to those having skill in the art that various mechanisms, e.g., color highlighting, could be used to notify a user that design criteria were not satisfied and to provide the warning message indicated in step 460 of spring design process 310.

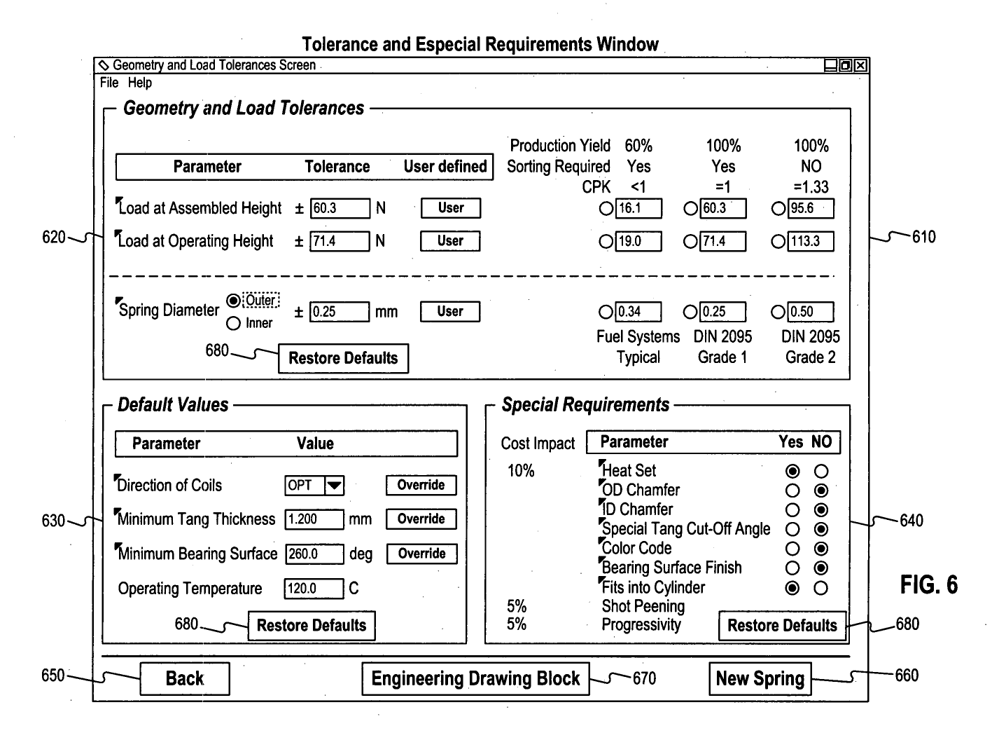

At step 470, spring design process 310 selects default values for the spring. Referring to FIG. 6, a geometry and load tolerances screen 610 is shown. Geometry and load tolerances screen indicates a number of default values useful in the design of a spring. According to one embodiment, the spring design process 310 selects these default values for a user. According to another embodiment, a user may input certain default values to geometry and load tolerances screen 610. FIG. 6 shows geometry and load tolerances screen 610 divided into three portions: geometry and load tolerance portion 620, default value portion 630, and special requirements portion 640. According to one embodiment, geometry and load tolerance portion 620 provides a user with an indication of load tolerances both at assembled height and operating height. Geometry and load tolerance portion 620 also provides an indication of the diameter of the spring and whether that diameter is the inner diameter or outer diameter. As can be seen from FIG. 6, the user is also given controls to indicate whether the load and spring diameter were chosen by a user or selected by spring design process 310. Geometry and load tolerance portion 620 also provides a user with certain information regarding the production yields for the spring design. In the instance shown in FIG. 6, geometry and load tolerance portion 620 provides a user with an indication for production yield at various CPK values. As will be apparent to one having skill in the art, different production yield information may be provided to a user.

Geometry and load tolerance screen 610 also includes a default value portion 630. Default value portion 630 indicates default values for “directional coils,” “minimum tang thickness,” “minimum bearing surface,” and “operating temperature.” As will be apparent to one of ordinary skill in the art, alternative default values may be provided.

Geometry and tolerance screen 610 includes special requirements portion 640. According to one embodiment, special requirements include the following: heat set, OD chamfer, ID chamfer, special tang cut-off angle, color code, bearing surface finish, fits into cylinder, shot-peening, and progressivity. According to one embodiment, these special requirements include yes/no radio buttons for a user to select whether or not the particular special requirements are desired in the spring being designed. Special requirements portion 640 also includes a cost impact column. The cost impact column indicates an approximate percentage increase in spring cost as a result of a particular special requirement parameter. As will be apparent to one having skill in the art, the list of special requirement parameters shown in special requirements portion 640 may be increased or decreased.

Viewing geometry and load tolerance screen 610 as a whole, it is noted that each of portions 620, 630, and 640 include a restore defaults button 680. Restore defaults button 680 enables a user of the spring design process 310 to restore default values for any of the three portions shown in geometry and load tolerance screen 610. According to another embodiment, restore defaults buttons 680 could be provided for each individual default value shown within FIG. 6. Geometry and load tolerance screen 610 also includes a number of operational controls in a bottom portion. According to one embodiment, geometry and load tolerance screen provides back button 650, new spring button 660 and engineering drawing block button 670. Engineering drawing block button 670 provides control for the user to advance to the next step of the spring design process. As will be apparent to one having skill in the art, any number of software control buttons may be provided on any of the screens of spring design process 310.

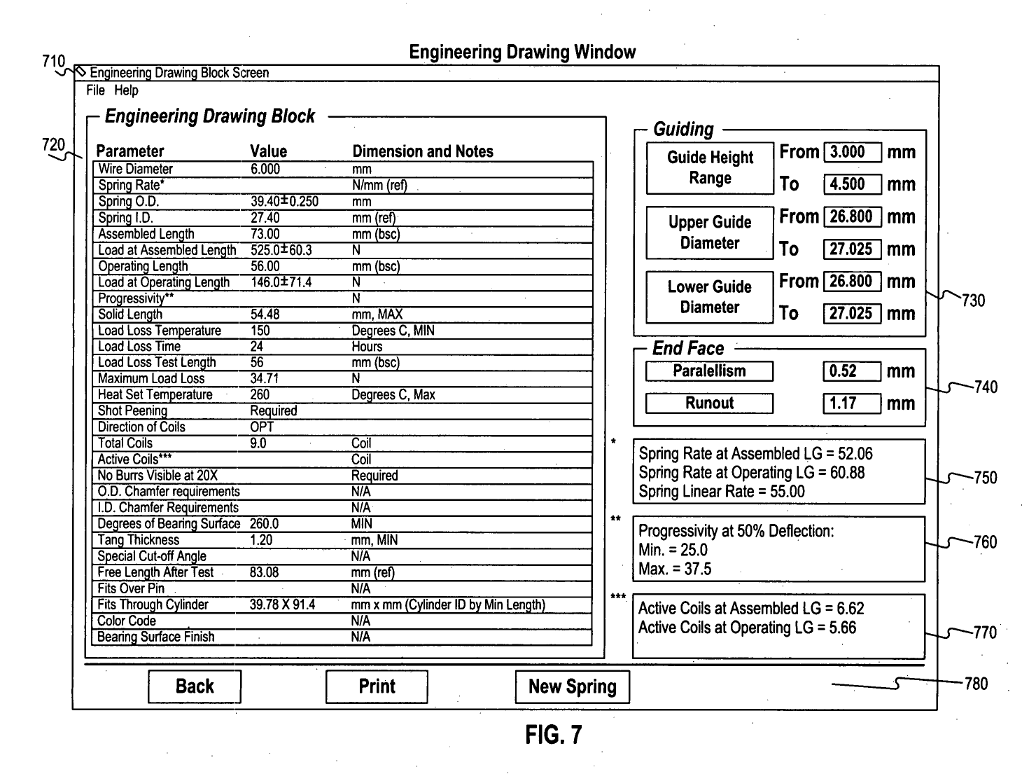

Returning to FIG. 4, engineering drawing block is provided at step 490. An exemplary engineering drawing block screen 710 is depicted in FIG. 7. Engineering drawing block screen 710 includes engineering drawing block 720, guiding portion 730, end face portion 740, spring rate block 750, progressivity block 760 and active coil block 770. According to one embodiment, engineering drawing block 720 provides a summary of all spring parameters, either entered by a user or determined by spring design process 310. That is, engineering drawing block 720 provides the spring design. According to one embodiment, all of the parameters listed in engineering drawing block 720 may be exported to a spreadsheet program. The spreadsheet file can then be used on an engineering drawing to describe all necessary spring parameters. According to one embodiment, spring rate block 750, progressivity block 760 and active coil block 770 are also provided. According to one embodiment, blocks 750-770 are used to highlight certain aspects of the spring design. Spring rate block 750 lists the spring rate under various conditions for the designed spring. Progressivity block 760 lists the progressivity limits for the designed spring. And, active coil block 770 lists the number of active coils for the designed spring. As will be apparent to one of ordinary skill in the art, engineering drawing block 720 and blocks 750, 760 and 770 may take the form of one or many blocks as desired.

Engineering drawing block screen 710 also includes guiding portion 730. According to one embodiment, guiding portion 730 includes separate portions that indicate guide height range, upper guide diameter, and lower guide diameter. Guiding indicates the dimensions within which a spring will operate. Using input side 520 of input/output window 510, a user specifies certain guiding parameters based on the desired spring design. Spring design process 310 determines and displays guiding conditions consistent with those user specified parameters.

Engineering drawing block screen 710 also includes end face portion 740. According to one embodiment, end face portion indicates parallelism and run-out factors for a spring being designed by spring design process 310. Parallelism factor indicates deviation from parallel for a helical coil spring being designed when that spring will be in operation. Run-out indicates the deviation of individual coils in a helical coil spring from each other when the spring is in operation. Advantageously, spring design process 310 may calculate both guiding and end face limits for the spring being designed. For example, for guiding, spring design process 310 provides upper and lower limits for guide height range, upper guide diameter and lower guide diameter. For parallelism and runout, spring design process 310 provides upper limits.

Engineering drawing block screen 710 also includes user control portion 780. According to one embodiment, user control portion 780 includes buttons for back, print, and new spring. It will be apparent to one having ordinary skill in the art that various user control functions can be provided within user control portion 780 of engineering drawing block screen 710.

In order to minimize the risk of spring failure from the spring design, an accurate dynamic analysis is conducted by spring analysis process 320 (FIG. 3). Spring analysis process 320 enables stress within each coil of the spring design to be determined and thereby enables identification of a coil or coils that experience the highest dynamic stress and have the lowest fatigue factor. The spring design can be adjusted accordingly using, for example, spring design process 310 in order to reduce the stress and improve the spring design.

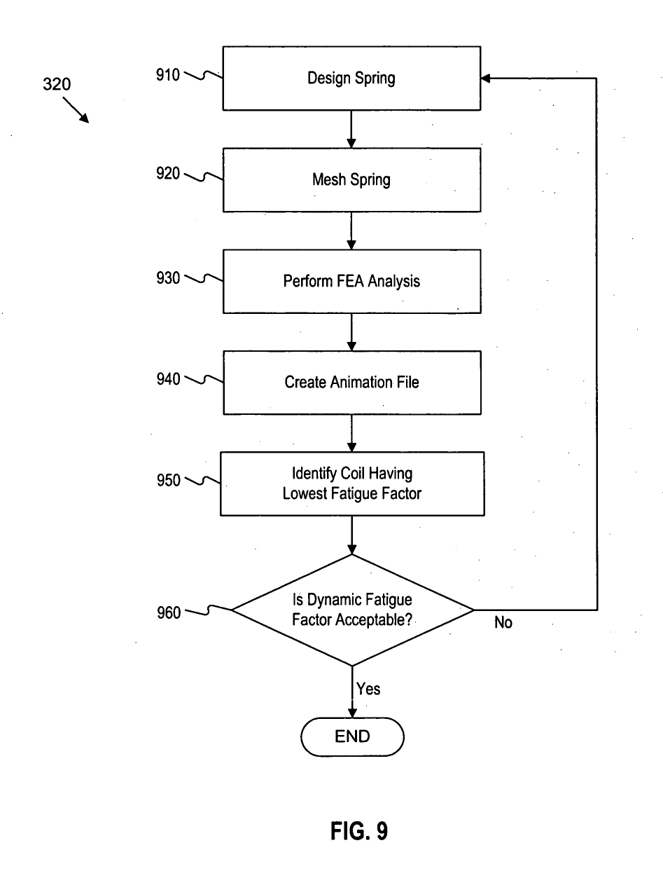

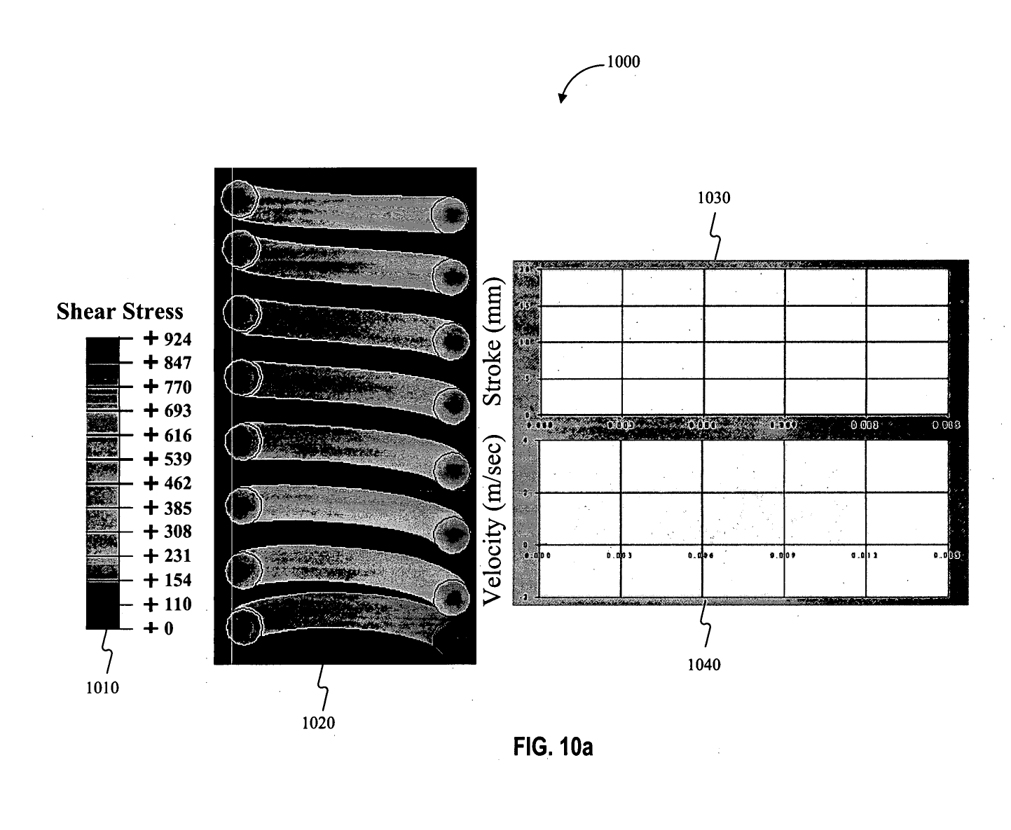

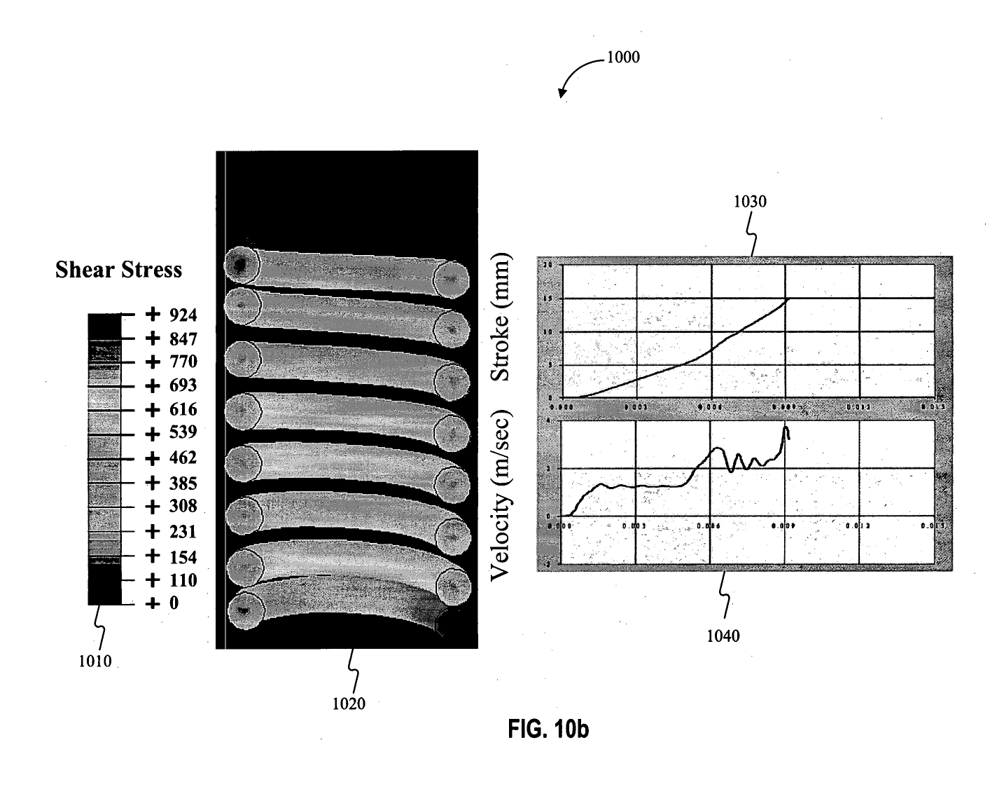

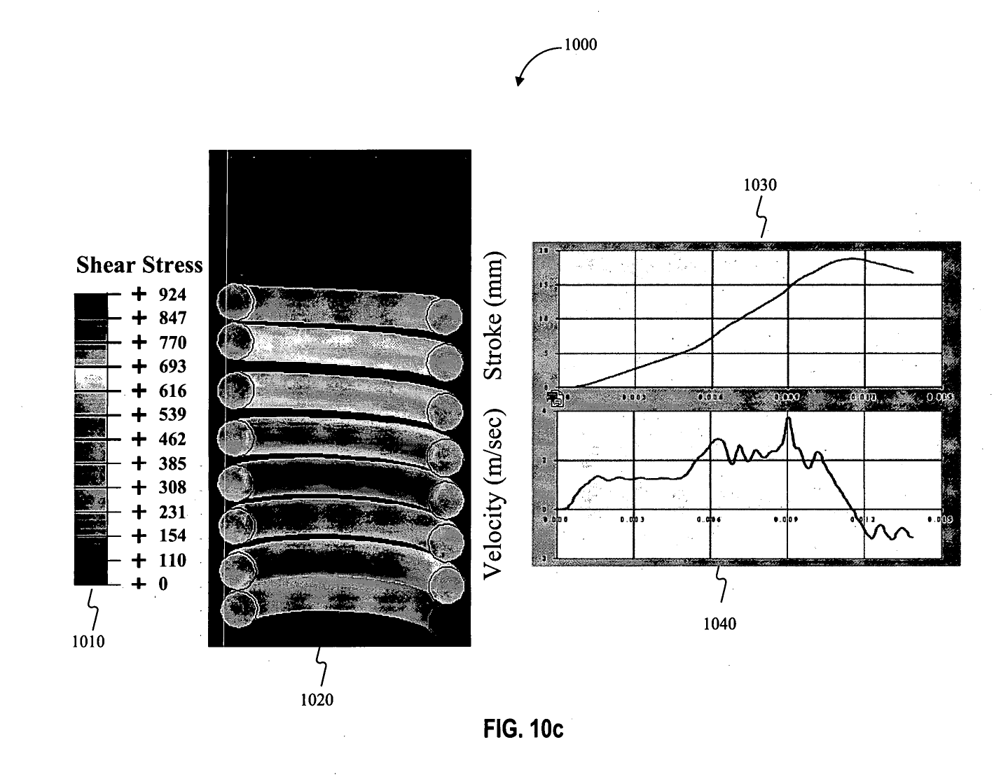

A flow chart depicting a spring analysis process 320 consistent with embodiments of the present disclosure is shown in FIG. 9. Spring analysis process 320 shown in FIG. 9 enables consideration of dynamic effects such as stress surges at the coil level and coil clash, as well as consideration of three-dimensional effects such as buckling and sheer at the spring ends. Spring analysis process 320 begins with the design of a spring at step 910. At step 920 the spring design is meshed with its break elements. A finite element analysis is done on the meshed spring at step 930. Then, an animation file is created from the output of the finite element analysis at step 940. The animation file enables dynamic effects on the spring design to be identified at the coil level. The coil having the lowest dynamic fatigue factor, is identified at step 950. At step 960, it is determined whether the determined minimum fatigue factor is acceptable based on the springs intended use. If the determined minimum fatigue factor is acceptable, then the spring analysis process 320 ends. If the determined minimum fatigue factor is unacceptable, then the operator is notified and spring analysis process 320 reverts control to spring design step 910. Each of steps 910 through 960 will be explained in more detail below in conjunction with FIGS. 9 and 10.

Spring analysis process 320 begins with the design of a spring at step 910. According to one embodiment, spring design may be accomplished using any software capable of designing a spring. According to another embodiment, spring design step 910 is accomplished by spring design process 310. Spring design process 310, as discussed above, is capable of both linear and non-linear spring design. One skilled in the art will recognize that spring analysis process 320 is also useful on springs designed using purely linear techniques.

At step 920, the designed spring is meshed with its break elements. As will be apparent to one of ordinary skill in the art, the process of meshing a solid is a preparatory step to a finite element analysis. In particular, meshing a solid body, such as a spring, involves determining where to break the solid into finite elements for analysis. According to one embodiment, the designed spring is meshed using software capable of meshing a spring with its break elements. For example, the CUBIT software, available from Sandia National Laboratories may be used to mesh the spring with its break elements. CUBIT includes a two- and three-dimensional finite element mesh generation tool. In particular, CUBIT includes a solid modeler based preprocessor that meshes volume and surface models for finite element analysis. CUBIT enables a spring to be meshed with its break elements. According to another embodiment, the designed spring is meshed using any suitable element structure, for example, tetrahedral elements. As will be apparent to one having ordinary skill in the art, any software capable of meshing a spring may be used.

At step 930, a finite element analysis is performed on the meshed spring design. According to one embodiment, a finite element analysis is performed on the meshed elements of the spring subjected to a dynamic excitation force. The finite element analysis models the response of the spring based on the response of the meshed elements. According to one embodiment, the Abaqus® (Abaqus is a registered trademark of Abaqus, Inc.) finite element analysis software is used to perform the finite element analysis. It will be apparent to one having skill in the art that various finite element methods may be used to perform the finite element analysis consistent with the teachings of the present disclosure.

At step 940, an animation file is created. According to one embodiment, the output from the finite element analysis is used to create an animation file. The animation file depicts the designed spring over time as it is subjected to a dynamic excitation force. Additionally, the animation file depicts varying levels of stress within the designed spring using grayscale or color variations. A bar graph could also be used to depict varying stress at the coil level. According to another embodiment, the animation file also depicts graphs of spring velocity and spring stroke (i.e., the displacement of the spring in response to the excitation force). For example, the animation file may depict the designed spring and the velocity and stroke curves side-by-side so that dynamic stress within the spring (as indicated by grayscale or color variations) may be compared with its velocity and stroke.

According to one embodiment, the animation file is created by creating and merging two separate animations. According to this embodiment, the results of the finite element analysis are used to create a first animation. This animation can be done, for example, using software such as Abaqus/Viewer® (Abaqus/Viewer is a registered trademark of Abaqus, Inc.) and Animation Shop™ (Animation Shop is a trademark of JASC Software) to create frames and improve frame quality, respectively. A second animation is also created. The second animation is created using, for example, a spreadsheet-type output from the finite element analysis and a frame creation software to create the velocity and stroke curves. According to one embodiment, a Visual Basic® (Visual Basic is a registered trademark of Microsoft Corporation) script can be used to export graphs from Microsoft Excel® (Excel is a registered trademark of Microsoft Corporation) to a frame creation software such as Microsoft PowerPoint® (PowerPoint is a registered trademark of Microsoft Corporation). The first animation and the second animation are then merged to develop the animation showing the spring and the springs velocity and stroke curves in side-by-side fashion. This animation enables stress within the spring to be monitored as the spring is subjected to the dynamic excitation force. It will be apparent to one having skill in the art that various programs could be used to develop the animation file consistent with the teachings of the present disclosure.

FIGS. 10a, 10b and 10c depict three exemplary frames 1000 from the animation. Each of frames 1000 depict a stress meter 1010, the spring design 1020, the stroke curve 1030 and velocity curve 1040. FIG. 10a depicts the spring design and stroke and velocity curves at time zero. That is, before any excitation force is applied. FIG. 10b depicts the spring design and stroke and velocity curves at some time after the dynamic excitation force is applied. Note, in FIG. 10b the oscillating velocity curve indicating that a dynamic force is being applied to the spring design. FIG. 10c depicts the spring design and stroke and velocity curves after the force has been removed. In FIGS. 10a-10c, stress meter 1010 provides a key to the level of stress within spring design 1020. That is, stress meter 1010 and spring design 1020 are shown in varying levels of gray scale. The varying levels of grayscale indicate varying levels of stress within spring design 1020. As can be seen from FIGS. 10a-10b, the stress levels within spring design 1020 vary from coil to coil and within a coil. A color scale could also be used for stress meter 1010 and for spring design 1020 to depict varying levels of stress.

At step 950, the coil having the lowest dynamic fatigue factor is identified. Reference will be made to FIGS. 10a-10c in the explanation of step 950. As discussed above, FIGS. 10a-10c depict frames from the spring animation created at step 940. As can be seen from FIGS. 10a-10c, the animation enables the spring designs response to the dynamic excitation force to be viewed at the individual coil level and enables the stress within the spring to be viewed at the individual coil level. According to one embodiment, the animation file is used to identify the coil that encounters the maximum stress in response to the dynamic excitation force. According to another embodiment, raw data from the finite element analysis could be used to determine the coil that encounters the highest stress in response to the dynamic excitation force.

At step 960, the dynamic fatigue factor of the identified coil is determined and evaluated against a predetermined threshold. As will be apparent to one having skill in the art, the fatigue factor or fatigue limit, is the maximum stress that an article can repeatedly endure without failing. According to one embodiment, the dynamic fatigue factor is determined from the animation by identifying the maximum stress that the spring repeatedly endures without failing. As discussed above, the animation enables a determination of stress to be made at the coil level.

According to one embodiment, the dynamic fatigue factor is evaluated against a minimum acceptable design criteria. According to another embodiment, the dynamic fatigue factor is evaluated against a minimum generally acceptable fatigue factor. If the dynamic fatigue factor is unacceptable, i.e., below some predetermined level, control returns to spring design step 910. The individual coil stress data developed through the finite element analysis in the animation file can be used to modify the spring design at 910. If the dynamic fatigue factor is acceptable at step 960, then spring analysis process 320 ends.

Variations of the methods and systems consistent with features of the present disclosure previously described may be implemented without departing from the scope of the disclosure. One skilled in the art would realize that the applications of methods and systems consistent with certain features related to the present disclosure are not limited to the examples listed above. For example, spring design process 310 and spring analysis process 320 may reside within client system 110 or within server system 130. Additionally any measure of spring non-linearity and any suitable spring design algorithm may be used. Furthermore, the teachings of the present disclosure maybe applied to design and analyze many different types of springs that are useful in many different environments.

Furthermore, methods and systems consistent with features of the present disclosure are not limited to the configuration and process sequences described and shown in the figures. For example, the present disclosure may be implemented using various network and computing models, protocols, and technologies. Also, methods and systems consistent with features of the present disclosure are not limited to the implementation of systems and processes compliant with the any particular type of programming language. Any number of programming languages may be utilized. Also, the present disclosure is not limited to end users located at a client system 110. One skilled in the art would realize that other entities may access server system 130 in a manner consistent with the present disclosure.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A spring design method, comprising:
inputting a first set of design parameters for a spring, the design parameters including a parameter that provides an estimate of non-linearity in the spring; and
determining a spring design based on the first set of design parameters.

2. The method of claim 1, wherein if the parameter that provides an estimate of non-linearity in the spring is non-zero, then the determining step determines a non-linear spring design.

3. The method of claim 1, wherein the inputting step further includes:
determining whether the first set of design parameters is logical; and
providing an indication where one or more parameter of the first set of design parameters is not logical.

4. The method of claim 1, wherein the step of determining a spring design includes determining a dynamic fatigue factor.

5. The method of claim 1, wherein the step of determining a spring design includes determining conditions related to mounting for the spring design.

6. The method of claim 1, further including:
comparing the spring design with design criteria;
determining if the design criteria were satisfied; and
determining a new spring design when the design criteria were not satisfied.

7. The method of claim 1, further including determining one or more default values for the spring design.

8. The method of claim 1, further including outputting a representation of the spring design.

9. The method of claim 1, wherein the parameter that provides an estimate of nonlinearity includes spring progressivity.

10. A spring design and analysis method, comprising:
creating a spring design, the spring design including a parameter that provides an estimate of non-linearity in the spring design;
creating a spring animation file, the spring animation file enabling stress levels in a spring design to be identified at the coil level;
identifying the coil in the spring design having the lowest dynamic fatigue factor, and
determining whether the lowest dynamic fatigue factor is acceptable.

11. The method of claim 10, further including meshing the spring design with its break elements.

12. The method of claim 11, further including performing a finite element analysis on the meshed spring design.

13. The spring design and analysis method of claim 10, wherein the step of determining whether the lowest dynamic fatigue factor is acceptable includes comparing the lowest dynamic fatigue factor to a predetermined threshold.

14. The spring design and analysis method of claim 13 wherein the predetermined threshold includes a stress value based on the intended use of the spring design.

15. The spring design and analysis method of claim 10 wherein the step of creating a spring animation file includes:
creating a first animation file depicting the spring design under a dynamic excitation force;
creating a second animation file depicting a graph of spring velocity under the dynamic excitation force; and
merging the first animation file and the second animation file into the spring animation file.

16. The spring design and analysis method of claim 15, wherein the second animation file depicts a graph of spring stroke.

17. The spring design and analysis method of claim 10, wherein the step of creating a spring design includes:
inputting a first set of design parameters for a spring, the design parameters including the parameter that provides an estimate of non-linearity in the spring; and
determining a spring design based on the first set of design parameters.

18. A spring design system, comprising:
a user interface configured to input a first set of design parameters for a spring, the design parameters including a parameter that provides an estimate of non-linearity in the spring;
a processor configured to determine a spring design based on the first set of design parameters; and
a display device configured to display the spring design.

19. The spring design system of claim 18, wherein the processor is operative to determine a non-linear spring design when the parameter that provides an estimate of non-linearity in the spring is non-zero.

20. The spring design system of claim 18, wherein the processor is configured to determine whether the first set of design parameters is logical and to provide an indication on the display device where one or more parameter of the first set of design parameters is not logical.

21. The spring design system of claim 18, wherein the processor is configured to determine a spring design including dynamic fatigue factor.

22. The spring design system of claim 18, wherein the processor is configured to determine conditions related to mounting for the spring design.

23. The spring design system of claim 18, wherein the processor is configured to compare the spring design with design criteria and to determine if the design criteria are satisfied.

24. The spring design system of claim 18, wherein the parameter that provides an estimate of non-linearity includes spring progressivity.

25. A spring design and analysis system, comprising:
a processor configured to:
create a spring design, the spring design including a parameter that provides an estimate of non-linearity in the spring design;
create a spring animation file, the spring animation file enabling stress levels in the spring design to be identified at the coil level;
identify the coil in the spring design having the lowest dynamic fatigue factor; and
determine whether the lowest dynamic fatigue factor is acceptable; and
a display device configured to display the animation to a user.

26. The spring design and analysis system of claim 25, wherein the processor is configured to:
mesh the spring design with its break elements; and
perform a finite element analysis on the meshed spring.

27. The spring design and analysis system of claim 25, wherein the processor is configured to compare the lowest dynamic fatigue factor to a predetermined threshold to determine whether the lowest dynamic fatigue factor is acceptable.

28. The spring design and analysis system of claim 27, wherein the predetermined threshold includes a stress value based on the intended use of the spring design.

29. The spring design and analysis system of claim 25, wherein the processor is configured to:
create a first animation file depicting the spring design under a dynamic excitation force;
create a second animation file depicting a graph of spring velocity under the dynamic excitation force; and
merge the first animation file and the second animation file into the spring animation file.

30. The spring design and analysis system of claim 29, wherein the second animation file depicts a graph of spring stroke.

31. The spring design and analysis system of claim 25, further including a user interface configured to input design parameters.

32. A method for designing a non-linear spring, comprising:
inputting design criteria for a spring, the design criteria including a parameter that provides an estimate of non-linearity in the spring; and
outputting a non-linear spring design based on the design criteria.

33. The method of claim 32, wherein the outputting step includes determining a non-linear spring design based on the design criteria.

34. The method of claim 32, wherein the inputting step further includes:
inputting a first set of design parameters;
determining whether the first set of design parameters is logical; and
providing an indication where one or more parameter of the first set of design parameters is not logical.

35. The method of claim 32, wherein the step of determining a spring design includes determining a dynamic fatigue factor.

36. The method of claim 32, wherein the step of determining a spring design includes determining conditions related to mounting for the spring design.

37. The method of claim 32, wherein the parameter that provides an estimate of nonlinearity includes spring progressivity.
